(19) United States
(12) Patent Application Publication
(10) Pub. No.: US 2025/0216125 A1
(43) Pub. Date: Jul. 3, 2025

(54) SYSTEMS AND METHODS FOR CONTROLLING FREEZING USING GAS

(71) Applicant: Ether Innovations Inc., Laval (CA)

(72) Inventors: Julien Michalk-Allaire, Montreal, QC (CA); Olivier Chamberland, Montreal, QC (CA); Anthony Ceniccola, Laval, QC (CA); Ousama Hraki, Montreal, QC (CA)

(21) Appl. No.: 18/853,118

(22) PCT Filed: Mar. 28, 2023
(86) PCT No.: PCT/CA2023/050418

§ 371 Date: Sep. 30, 2024

Related U.S. Application Data
(60) Provisional application No. 63/362,008, filed on Mar. 28, 2022.

(51) Int. Cl. F25B 19/00; A23B 2/00; A23B 2/88

(52) U.S. Cl. CPC F25B 19/005; A23B 2/001; A23B 2/003; A23B 2/88

(57) ABSTRACT

The invention is a freezing apparatus and method for freezing a liquid in a rapid and efficient manner. The apparatus includes a frame, a freezing mold assembly that is removably mounted within the frame, and a central nozzle for distributing the freezing liquid throughout the mold assembly. The freezing mold assembly includes a plurality of freezing cells that are configured to receive the liquid and freeze it quickly, while the central nozzle distributes the liquid evenly throughout the mold assembly to ensure consistent freezing. The method includes the steps of filling the freezing cells with the liquid, activating the central nozzle to distribute the liquid evenly, and rapidly freezing the liquid in the cells. The apparatus also includes a demolding assembly for gently unfreezing the frozen content to enable easy demolding.

### CROSS-REFERENCE TO RELATED APPLICATIONS

The present patent application claims the benefits of priority of U.S. Patent Application No. 63/362,008 entitled “SYSTEMS AND METHODS FOR CONTROLLING FREEZING USING GAS” and filed at the United States Patents and Trademark Office on Mar. 28, 2022, the content of which is incorporated herein by reference.

### FIELD OF THE INVENTION

The present invention generally relates to apparatuses directed to freezing fluids or food. More particularly, the present invention relates to systems and method for controlling freezing of fluid or food using a gas, such as connecting a fluid cartridge to apparatuses that allow the freezing of consumable fluids or food in a short lapse of time or controlling activation/deactivation of gas flow to the instant freezing apparatus.

### BACKGROUND OF THE INVENTION

Alcohol has been consumed by humans for hundreds of years. However, the entertainment and food industries are always on the lookout for new features to make the alcohol consumption a novel and unique experience.

The way alcohol is served typically varies from country to country and to some extent may depend on cultures. In northern countries, some bartenders created ice glasses in which people enjoy cold alcoholic beverages. Similarly, prior art methods comprise cryogenically freezing all sorts of foods including alcohol.

While the idea of serving iced beverages has been around for some time, existing regulations relating to the food and entertainment industries in several jurisdictions prevent bar owners from pre-freezing drinks such as alcohol shots thereby rendering the serving of frozen beverages somewhat unappealing.

Furthermore, while the control of the gas flow may be performed using an electronic or electric controller, an apparatus connected to an electric source of more than 12 volt and to a gas source must be certified to be sold and/operated. Such process is lengthy and complex while limiting the positioning of the resulting apparatus to location close or adjacent to an electrical source.

Several prior art documents disclose methods for making cryogenically freezing food or liquids which typically rely on compressed fluid cartridges as a source of rapid cooling. For example, U.S. Pat. No. 11,039,632, incorporated herein by reference, discloses an instant freezer apparatus using compressed fluid to rapidly cool a mold having a plurality of freezing cells adapted to hold a fluid. However, the installation of said fluid cartridges in an apparatus for freezing liquid can be complex and time consuming, especially in a dark setting such as a bar.

There is therefore a need for a system and method for rapidly connecting a fluid cartridge.

### SUMMARY OF THE INVENTION

The shortcomings of the prior art are generally mitigated by a system and method for connecting a fluid cartridge as described herein.

Other and further aspects and advantages of the present invention will be obvious upon an understanding of the illustrative embodiments about to be described or will be indicated in the appended claims, and various advantages not referred to herein will occur to one skilled in the art upon employment of the invention in practice.

### BRIEF DESCRIPTION OF THE DRAWINGS

The above and other aspects, features and advantages of the invention will become more readily apparent from the following description, reference being made to the accompanying drawings in which:

FIG. 1 is a perspective view of an instant freezer apparatus according to the principles of the present invention.

FIG. 2 is a perspective view of the instant freezer apparatus of FIG. 1 shown with an open receptacle lid.

FIG. 3 is an exploded perspective view of the instant freezer apparatus of FIG. 1.

FIG. 4 is a front elevation view of the instant freezer apparatus of FIG. 1.

FIG. 5 is a top plan view of the instant freezer apparatus of FIG. 1.

FIG. 6 is a top plan view of the instant freezer apparatus of FIG. 1 shown with an open receptacle lid.

FIG. 7 is a front elevation view of a freezing fluid injector assembly of the instant freezer apparatus of FIG. 1.

FIG. 8 is a front elevation view of a cartridge mount of the freezing fluid injector assembly of FIG. 7.

FIG. 9 is a front elevation view of a connector element and valve mount of the freezing fluid injector assembly of FIG. 7.

FIG. 10 is a front elevation view of a connector element and valve mount of the freezing fluid injector assembly of FIG. 7.

FIG. 11 is a front elevation view of a control system of the instant freezer apparatus of FIG. 1.

FIG. 12 is a side view of a section of another embodiment of the freezer apparatus according to the principles of the present invention, shown with the cover open.

FIG. 13 is perspective view of the apparatus of FIG. 12, shown with the cover open.

FIG. 14 is a front view of the freezer apparatus of FIG. 12, shown with the cover open.

FIG. 15 is a side view of the instant freezer apparatus of FIG. 12, shown with the cover open.

FIG. 16 is a back view of the instant freezer apparatus of FIG. 12 shown with the cover open.

FIG. 17 is a perspective view of a section of the instant freezer apparatus of FIG. 12, shown with the cover open.

FIG. 18 is a perspective view of the gas distribution system of the instant freezer apparatus of FIG. 12.

FIG. 19 is a bottom perspective view of an embodiment of a freezing module comprising a flexible base according to the principles of the present invention.

FIG. 20 is a sectional side view of the freezing module of FIG. 19.

FIG. 21 is a perspective view of an inner portion of an embodiment of a freezing apparatus according to the principles of the present invention shown without a freezing chamber.

### DETAILED DESCRIPTION OF THE INVENTION

Novel systems and methods for controlling freezing using gas will be described hereinafter. Although the invention is described in terms of specific illustrative embodiments, it is to be understood that the embodiments described herein are by way of example only and that the scope of the invention is not intended to be limited thereby.

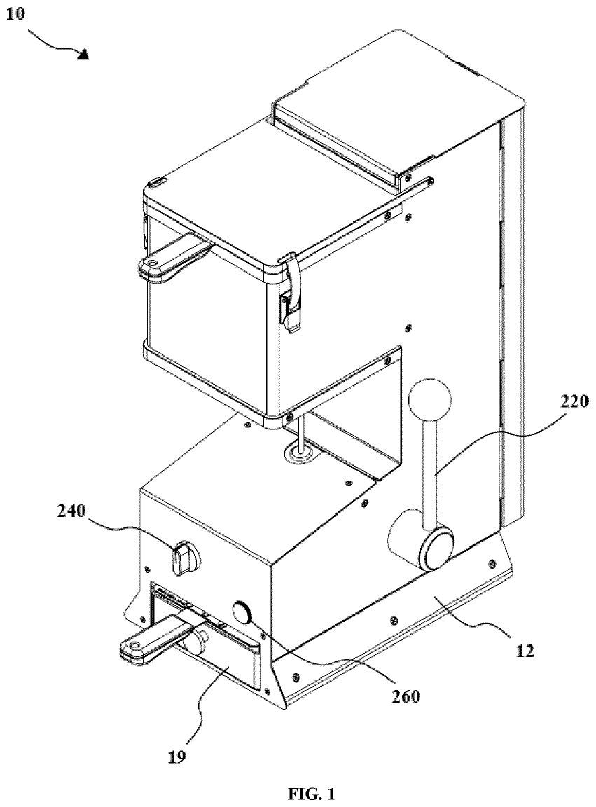

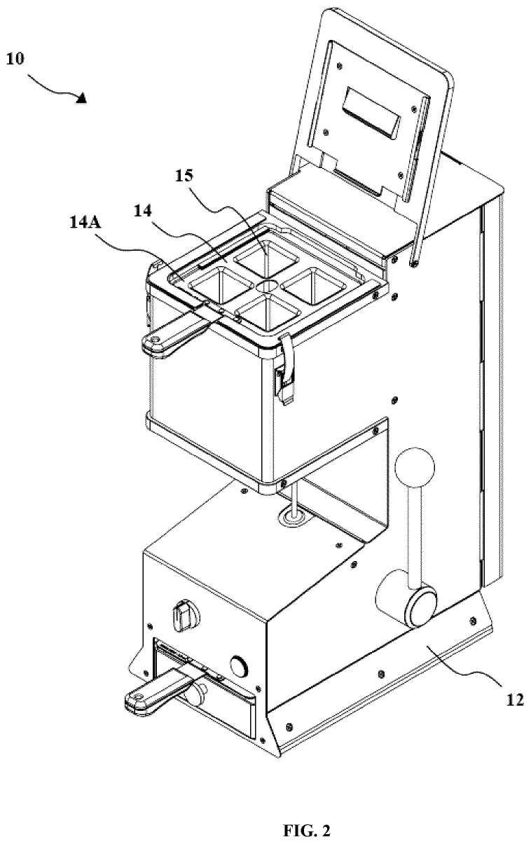

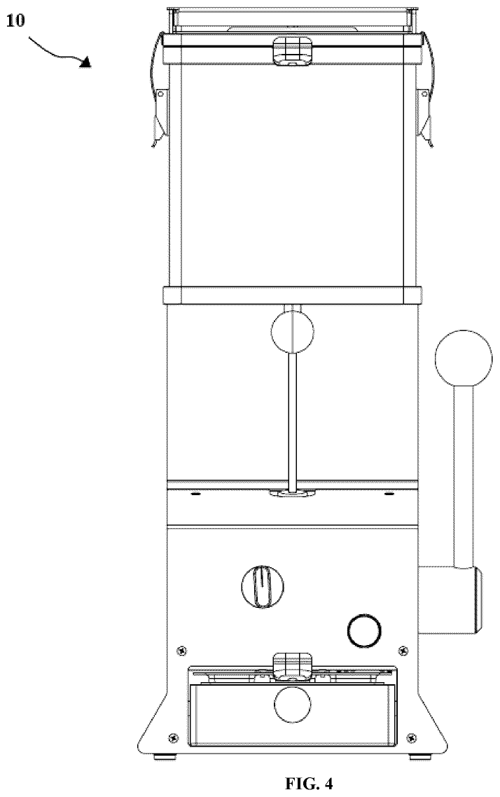

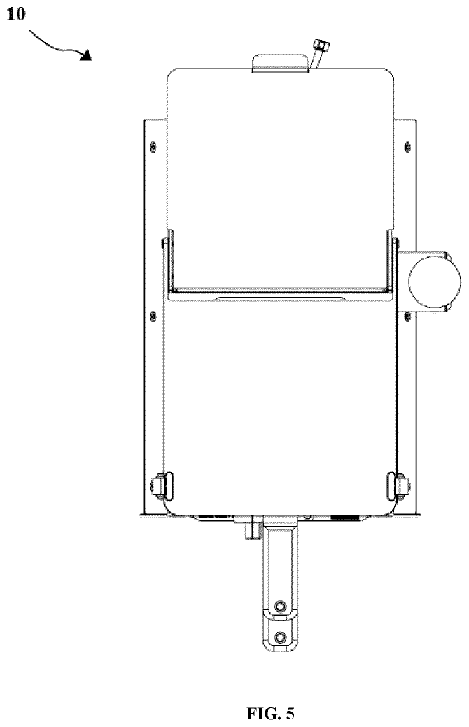

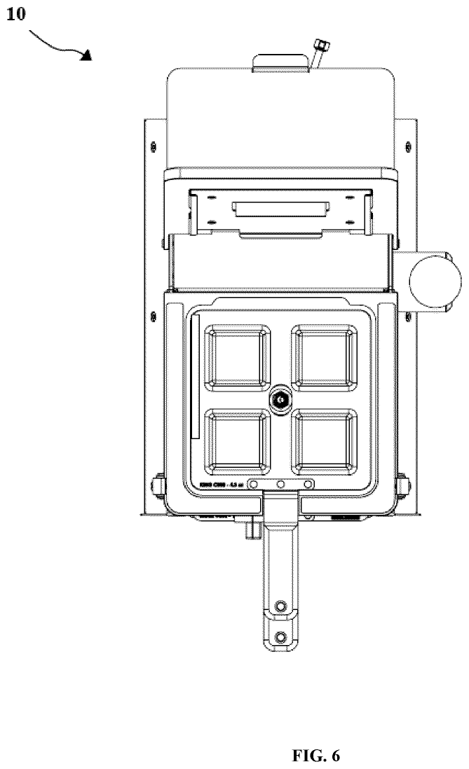

Now referring to FIGS. 1 to 6, an embodiment of an instant freezing apparatus 10 is shown. The instant freezing apparatus generally comprises a main frame 12 and a removable freezing module 14, also referred herein as a freezing mold 14. The freezing apparatus 10 comprises a freezing chamber 16 in fluid (such as gas) communication with the freezing mold 14. In the present embodiment, a top portion of the freezing chamber 16 is openable and shaped to receive the freezing module 10. The freezing chamber 16 is fluidly connected to a gas source such as, for example, a fluid cartridge 20, such as a gas tank or bottle. The apparatus 10 further comprises a gas control system 200. The gas control system 200 selectively controls the flow of gas to the freezing chamber 16. The gas control system 200 generally control the flow rate of gas to the freezing chamber 16, the activation and deactivation of the flow of gas and emergency stopping of the gas flow.

The freezing apparatus 10 may further comprise a housing, cover or body adapted to cover the freezing apparatus 10.

The freezing mold 14 is removable from the freezing chamber 16. The freezing mold typically comprises one or more freezing cells 15 for receiving a liquid to be frozen. The freezing cells 15 may be shaped according to any desired shaped for freezing the fluid or food, such as but not limited to a cuboid, a parallelepiped or a rectangular prism. Understandably, the freezing cells 15 may have any shape adapted to contain a substance to be frozen, such as liquid substance, without departing from the principles of the present invention. In the illustrated embodiment, the freezing mold 14 comprises a top surface 14A defining the upper edges of the freezing cells 15 which are downwardly extending from said top surface 14A in a way to form a pocket adapted to receive fluids or consumable food to be frozen. In the embodiment shown in FIGS. 1 to 6, the freezing mold 14 comprises four freezing cells 15 split in two rows of two cells. Understandably, the freezing mold 14 may comprise any other suitable number of freezing cells 15. The volume of each freezing cell 15 generally matches the volume of the fluid to be frozen. As an example, a 40% volume/volume alcohol drink would typically be frozen in a one to one and a half ounce (30 to 45 ml).

The freezing mold 14 further comprises a bottom surface, typically opposite to the top surface. The bottom surface is adapted to be in fluid communication or contact with the gas present in the freezing chamber 16. The freezing mold 14 may further comprise a handle, or any other means to manipulate the freezing mold 14, In the illustrated embodiment, the handle or manipulation element extends from the top surface 14A of the freezing mold 14.

The apparatus 10 further comprises a freezing fluid injector assembly in fluid communication with the freezing chamber 16. The fluid injector assembly typically comprises an inlet fluidly connected to the gas source and a nozzle distributing gas into the freezing chamber 16.

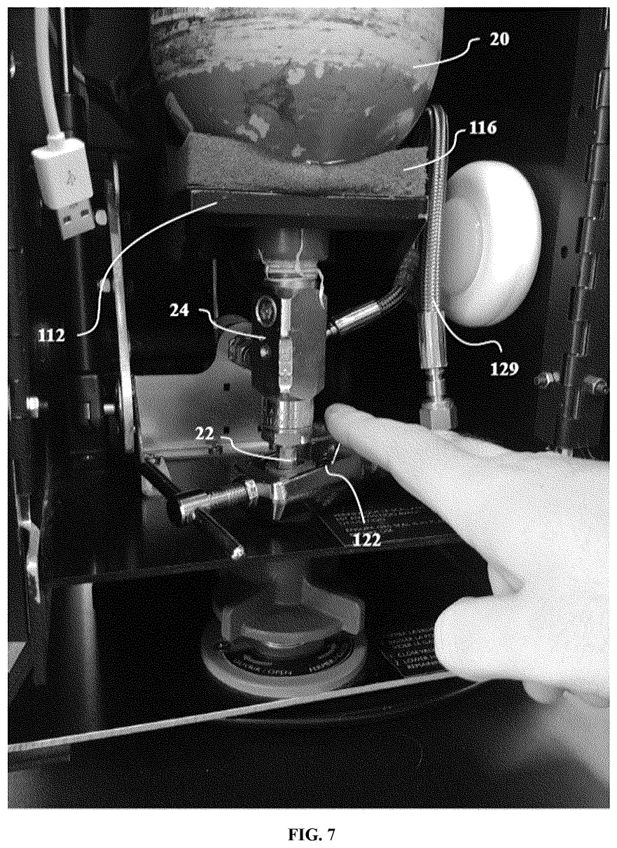

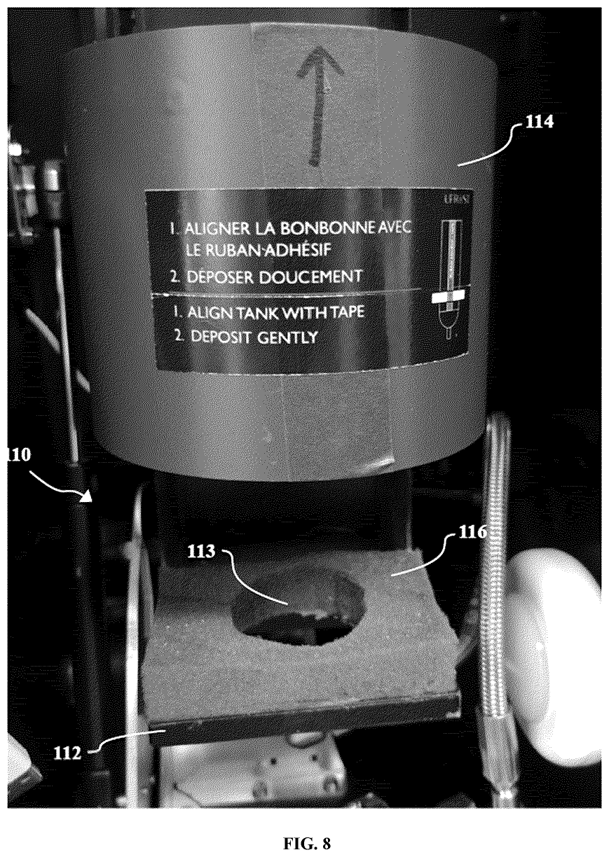

Now referring to FIGS. 7 to 10, a cartridge connecting assembly 100 of the instant freeze apparatus 10 is shown. The cartridge connecting assembly 100 generally comprises a cartridge mount 110, a cartridge connector 120 operatively connected to the fluid cartridge 20 and to the fluid injector assembly, and a valve mount 130 adapted to receive and operatively engage a valve stem 22 of the fluid cartridge 20.

The cartridge mount 110 generally aims at receiving and maintaining a fluid cartridge 20 in a downward position. The downward position is desirable to optimize the distribution of the fluid present in the fluid cartridge 20, such as but not limited to carbon dioxide. The cartridge mount 110 typically comprises a mounting plate 112 and a retaining sleeve 114 affixed to the frame 12. The cartridge mount 110 is generally adapted to receive and retain the fluid cartridge 20 in a downward facing position. The mounting plate 112 may further comprise a plate aperture 113 adapted to allow a nozzle 24 of the fluid cartridge 20 to pass therethrough. Understandably, any suitable structure may be used for retaining the fluid cartridge 20 in a suitable downward position. The mounting plate 112 generally aims at receiving and holding the shoulders of the fluid cartridge 20.

In certain embodiments, the cartridge mount 110 may further comprise a resilient or compressible padding element 116 configured to prevent undesirable damage to the fluid cartridge 20 during installation. Indeed, the padding element 116 may be adapted to absorb the shock of the gas cartridge 20 when the said gas cartridge 20 is lowered toward the mounting plate 112.

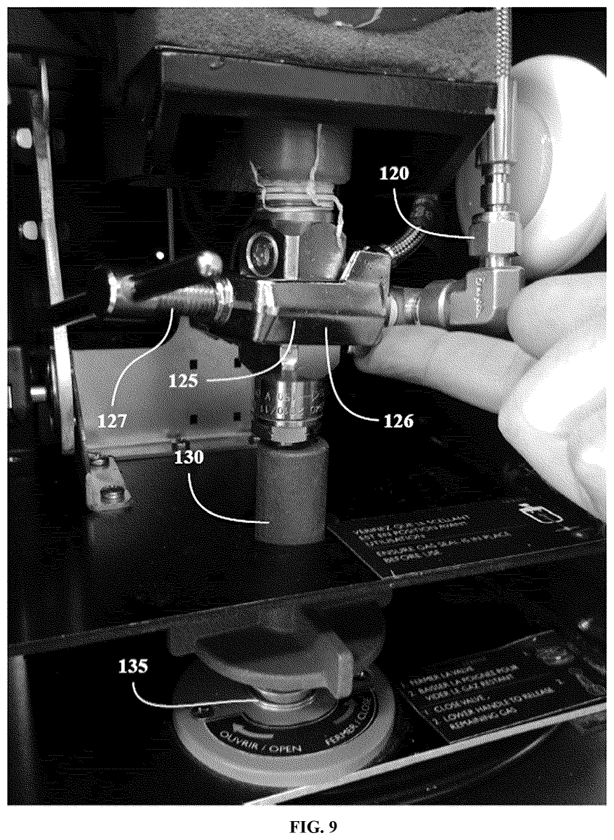

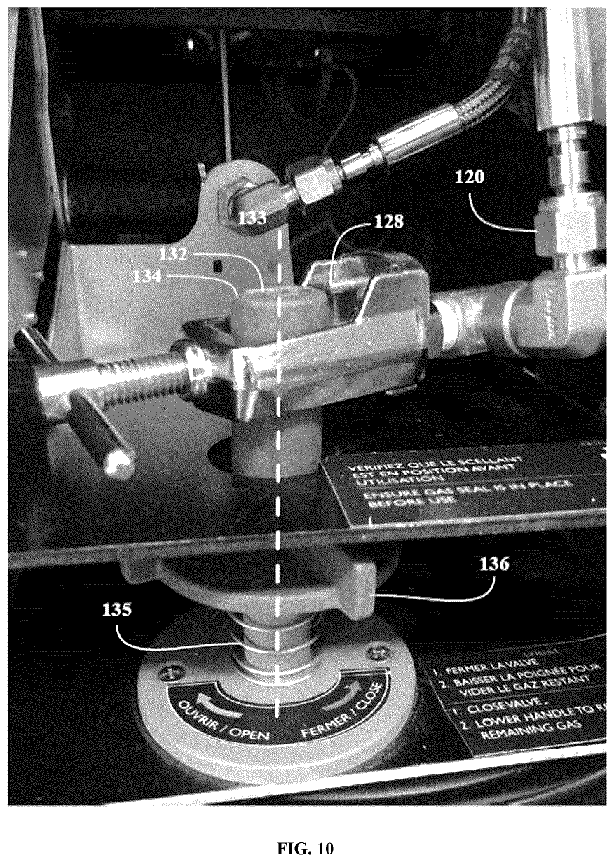

Referring now to FIGS. 9 and 10, the cartridge connector 120 is shown in a connected and disconnected configuration, respectively. Broadly, the cartridge connector 120 may be secured and fluidly connected to the nozzle 24 of the fluid cartridge 20 such as to receive the compressed fluid contained within said downwardly mounted fluid cartridge 20. The cartridge connector 120 comprises a fluid inlet 122 (shown in FIG. 7) adapted to sealingly connect to a nozzle outlet (not shown) of the nozzle 24 when the cartridge connector 120 is connected to the fluid cartridge 20. The cartridge connector 120 is configured to be vertically displaced to align the height of the cartridge connector 120 with the height of the nozzle 24 of the gas cartridge 20. In the illustrated embodiment, the cartridge connector 120 is fluidly connected to a flexible cable 129 which allows vertical movement of the cartridge connector 120.

The cartridge connector 120 may further comprise a securing member 125 configured to selectively secure the connector element 120 to the nozzle 120. In the embodiment shown in FIGS. 9 and 10, the securing member 125 comprises a bracket 126 comprising a threaded hole adapted to receive a knob 127 therein. Once the connector element 120 has been placed in a desirable position, the knob 127 may be selectively threaded within the bracket 126 to compress the nozzle 24 within the cartridge connector 120 thereby securing both elements together. In the present embodiment, the securing member 125 is a standard connector, such as carbon dioxide yoke assembly (CGA 940).

In certain embodiments, the cartridge connector 120 further comprises one or more alignment members 128 (see FIG. 10) configured to be received within alignment cavities (not shown) of the nozzle 24. The alignment members 128 may allow an easier alignment of the fluid inlet 122 with the nozzle outlet of the nozzle 24. In the illustrated embodiment, the alignment members 128 are protruding pins. Understandably, the connector element 120 may comprise any other suitable structure for easily and rapidly aligning the fluid inlet 122 and nozzle outlet of the nozzle 24.

In a preferred embodiment, the instant freeze apparatus 10 is configured to receive an industry standard fluid cartridge 20 comprising a rectangular valve stem 22, such as a medical grade carbon dioxide cylinder. Such standard fluid cartridge 20 comprises a top valve generally adapted to be rotated to selectively open and close the said valve of the fluid cartridge 20. During manufacturing, the valve stem 22 is typically arbitrarily positioned about its rotation axis.

Referring now to FIGS. 9 and 10, the apparatus 10 generally comprises the rotatable valve mount 130. The valve mount 130 may be adapted to rotate about a generally vertical axis to align a valve tip receptacle 132 thereof with the valve stem 22. Still referring to FIGS. 9 and 10, an embodiment of the rotatable valve mount 130 of the freezing fluid injector assembly 100 is shown. The valve mount 130 generally comprises a tip receptacle 132, a rotative body 136 and a resilient member 135. The tip receptacle 132 comprises a recess similarly shaped to that of the valve stem 22 and configured to retain and to rotatably engage the valve stem 22 of the fluid cartridge 20 about its longitudinal rotation axis 133. Understandably, the tip receptacle 132 may have any other shape suitable for rotatably engaging the valve stem 122 of the fluid cartridge 20. The resilient member 135 (such as a spring) is positioned between valve mount 130 and the main frame 12 and adapted to push the valve mount 130 upwards towards the fluid cartridge 20.

In the illustrated embodiment, the resilient member 135 comprises a spring and cylindrical member attached to the frame 12. The rotative body 136 comprises a recess adapted to rotate over the cylindrical member and a bottom portion adapted to push against the spring. In some embodiments, the rotative body 136 may comprise an enlarged portion acting as the rotative handle to open or close the valve of the connected cartridge 20.

During an exemplary installation of the fluid cartridge 20, the fluid cartridge 20 may be lowered into the cartridge mount 110 with the valve stem 22 lowered towards the valve mount 130. More specifically, the fluid cartridge 20 may slide into the retaining sleeve 114 and lowered onto the padding element 116 of the cartridge mount 110. As shown in FIG. 7, if the valve stem 22 and the valve tip receptacle 132 are not appropriately aligned, the valve stem 22 may press against an upper face 134 of the valve mount 130 thereby pressing the valve mount 130 downwards. The valve mount 130 may therefore be rotated about its rotation axis 133 to realign the valve tip receptacle 132 with the valve stem 22. As shown in FIG. 9, once said valve tip receptacle 132 and valve stem 22 are appropriately aligned, the valve stem 22 may no longer be pressed against the upper face 134 thereby allowing the resilient member 135 to push the valve mount 130 upwards and the valve stem 22 to be retained within the valve tip receptacle 132. In this configuration, the valve tip receptacle 132 and valve stem 22 are operatively connected and a further rotation of the valve mount 130 will actuate a rotation of the valve stem 22. Accordingly, the valve mount 130 may be rotated within the main frame 12 to selectively open and close the valve of the fluid cartridge 20.

To ensure that the cartridge connector 120 is aligned with the outlet of the fluid cartridge 20, the fluid cartridge 20 shall be slid with its nozzle outlet facing the fluid inlet 122 of the cartridge connector 120.

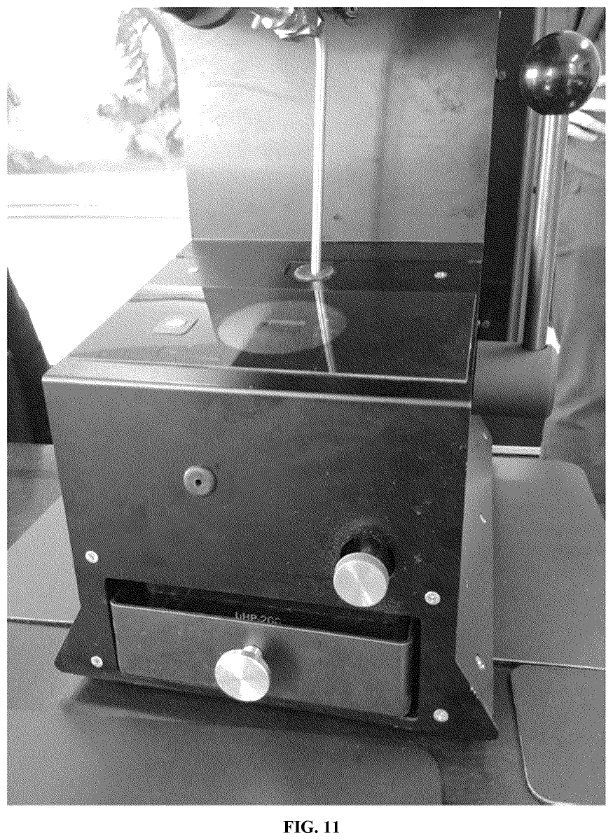

Referring back to FIGS. 1 to 6 and 11, the instant freeze apparatus 10 further comprises a control system 200 configured to selectively activate the release of the fluid from the fluid cartridge 20 towards the freezing chamber 16 to enable a rapid freezing of the contents contained therein and deactivate or stop the flow of fluid toward the freezing chamber 16.

The control system 200 generally comprises a switch mechanism 220 configured to activate the rapid freezing process, a timer mechanism 240 configured to select a desired freezing time, an emergency stop button 260 configured to rapidly stop the freezing process, and a retaining mechanism 280.

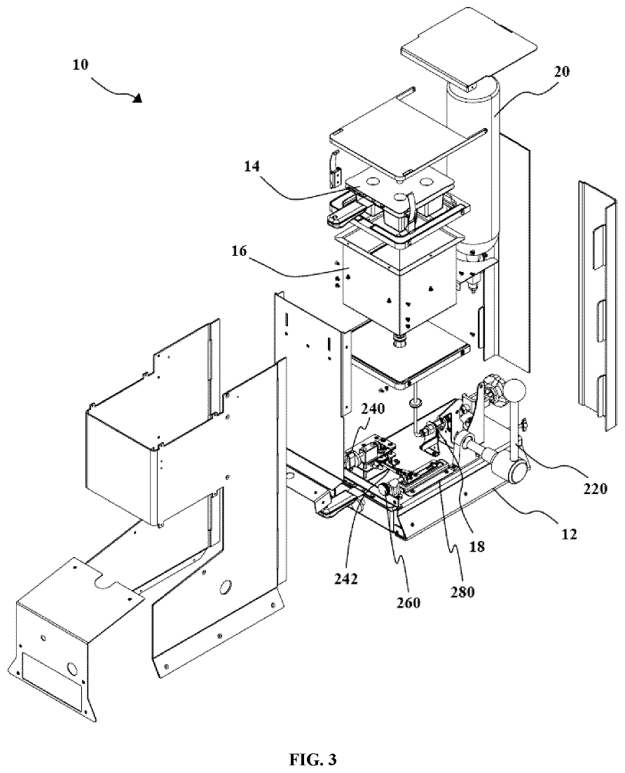

Referring to FIG. 3, the switch mechanism 220 is generally embodied as a lever arm 222 rotatably connected to a gate of a passthrough valve 18 which restricts fluid flow from the fluid cartridge 20 towards the freezing chamber 16. A rotation of the lever arm 222 may therefore actuate the gate of the passthrough valve 18 to release the compressed fluid from the connector element 120. In the illustrated embodiment, the lever arm 222 is attached to a shaft pivoting in a bracket attached to the frame 12. The pivoting of the shaft drives the opening and closing of a ball valve connected between the cartridge connector 120 and the freezing chamber 16.

The switch mechanism 220 may further comprise a resilient member (not shown) adapted to impel the lever arm 222 back to its inactive or closed position. The switch mechanism 220 may further comprise a bracket 226 configured to be selectively secured to the retaining mechanism 280 thereby preventing the resilient member from pre-emptively rotating the lever arm 222 back to a closed position.

The switch mechanism typically comprises a protuberant member, such as an elongated member or latch, radially extending from the shaft. As the shaft pivots, the elongated member is inserted into a movable slot or aperture of the retaining mechanism 280. As the elongated member is inserted into the movable slot, the lever arm 222 is locked into place (allowing the fluid to flow).

The timer mechanism 240 may comprise any suitable analogue or digital timer mechanism. In a preferred embodiment, the timer mechanism 240 is configured to mechanically release the retaining mechanism 280 after a predetermined period of time associated with the time necessary for freezing the liquid within the freezing mold 14.

In embodiments having a mechanical timer, the mechanism 240 comprises an arm or link connector 242 attached to the movable slot. When the mechanical timer 240 ends after the predetermined time, the arm 242 moves to disengage the elongated member of the switch mechanism. As the elongated member is disengaged, the lever arm 222 rotates back to the initial position, thus turning off the ball valve to restrict the flow of fluid.

In some embodiments having a digital timer mechanism 240, the timer mechanism comprises a display unit, one or more buttons, a control board and a servo motor. The display unit and one or more buttons and the servo motor are operatively connected to the control board. The control board is typically programmed or designed to start a timer upon pressing of a button or when the switch mechanism 220 is activated. When the timer reaches a desired or predetermined period of time (such as, for example, 90 seconds), the control board may send a control signal to activate the servo motor. The servo motor moves towards the switch mechanism and disengages the said switch mechanism to restrict flow of the fluid to the freezing chamber 16. Understandably, the timer may be set to disengage the switch mechanism 220 before the end of the timer as the fluid injected in the freezing chamber 16 during the lapsed time will be sufficient to maintain the freezing temperature in the freezing chamber 16 for the remainder of the set period of the timer.

In one embodiment, the servo motor moves the movable slot to disengage the elongated member of the switch mechanism. As the elongated member is disengaged, the lever arm 222 rotates back to the initial position, thus turning off the ball valve to restrict the flow of fluid.

In certain embodiments, the timer mechanism 240 may comprise a plurality of buttons or switches wherein each button or switch is associated with a different predetermined time period. The different buttons or switches may therefore allow a user to rapidly select a desired freezing period associated with the contents of the freezing mold 14.

Still referring to FIG. 3, the emergency stop button 260 may comprise a mechanical linkage configured to bypass the timer mechanism 240 in order to release the retaining mechanism 280. In the illustrated embodiment, the pressing of the button activates the mechanical linkage which mechanically moves the movable slot to disengage the elongated member. When the elongated member is disengaged, the lever arm 222 rotates back to the initial position and turns off the ball valve.

The apparatus 10 may further comprise a demolding assembly 19. The demolding assembly typically comprises a slidable container having a shape suitable to receive the bottom portion of the removable freezing mold 14. As such, when the freezing process is completed, the freezing mold 14 may be inserted into the liquid-filled container to gently expedite the unfreezing process. Such process enables easy demolding of the frozen content present in the freezing cells 15. The container may be embodied as a drawer slidable into the frame 12 of the apparatus 10.

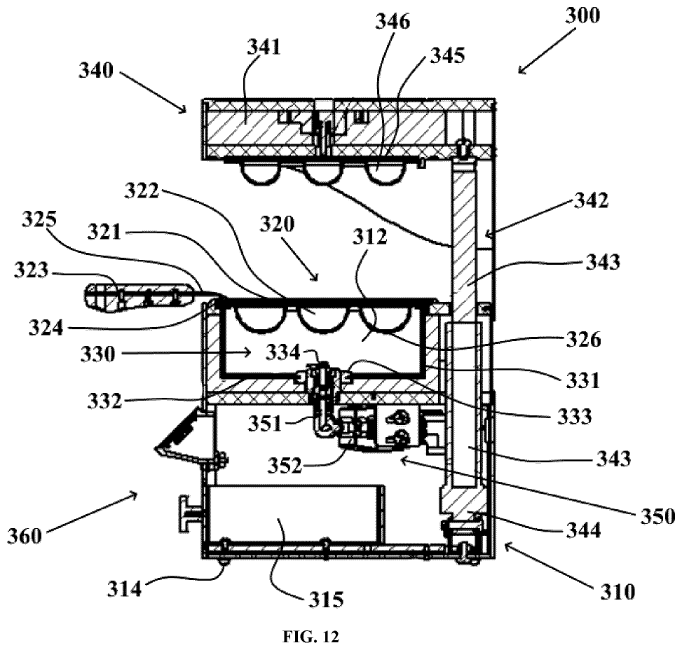

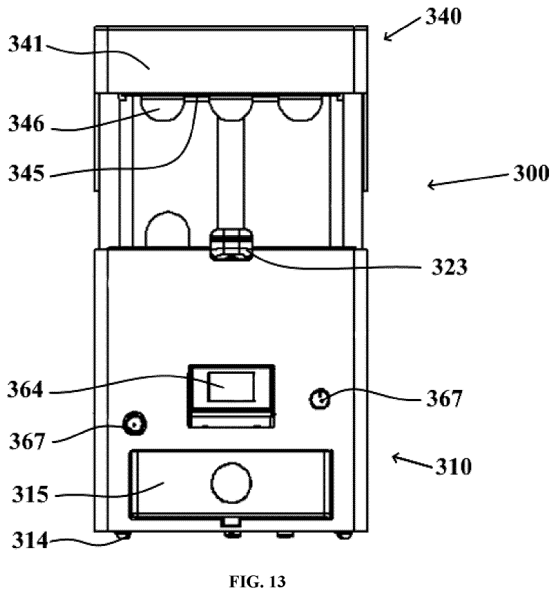

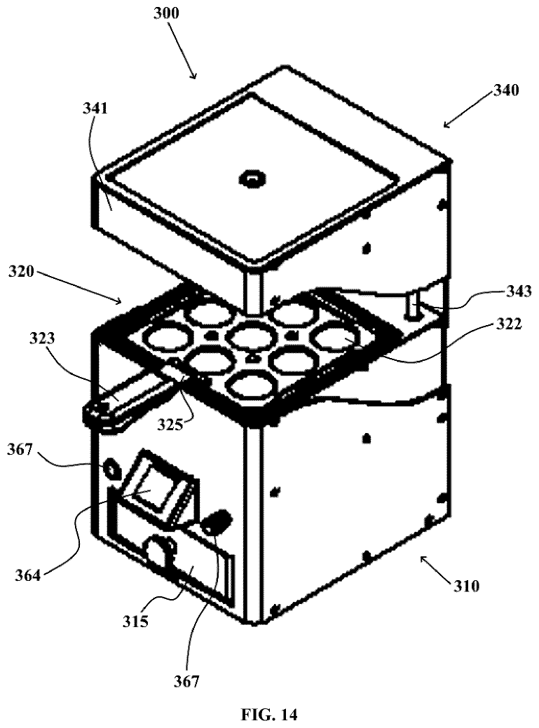

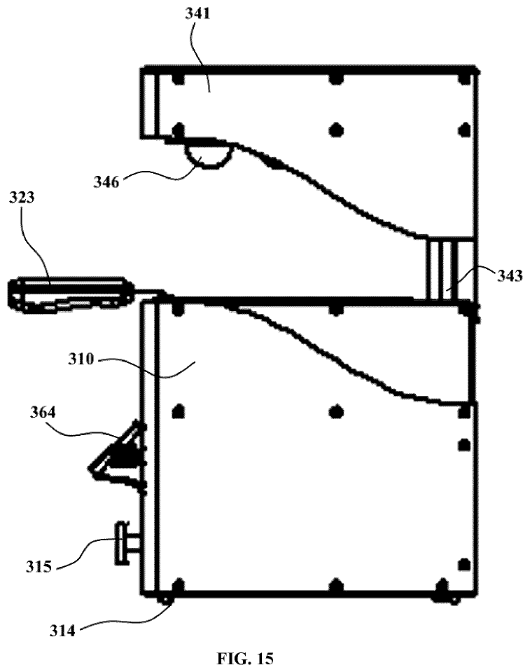

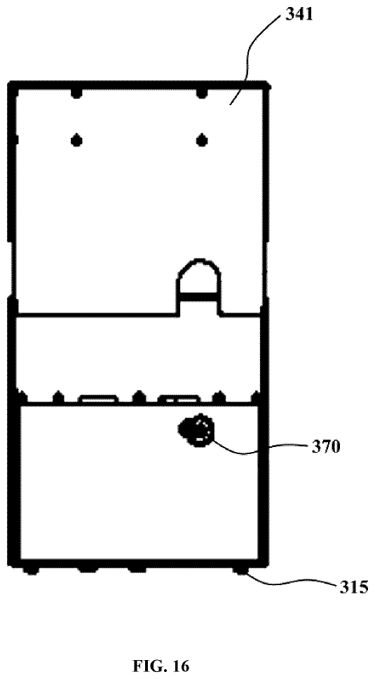

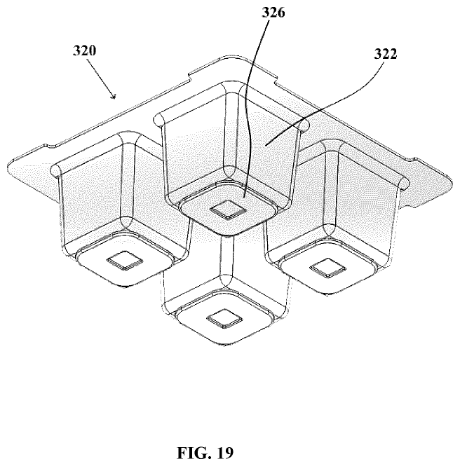

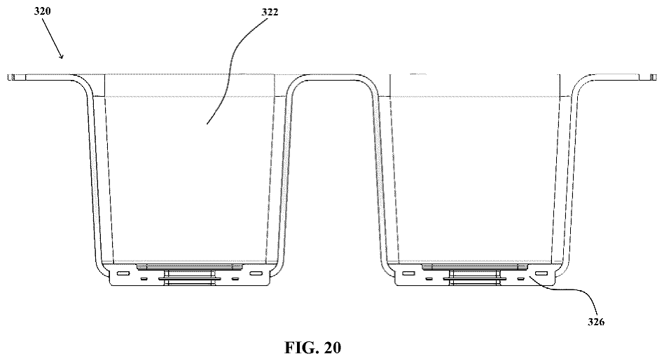

Referring now to FIGS. 12 to 21, another embodiment of an apparatus for controlling freezing using gas is shown. The apparatus 300 illustrated at FIG. 12 generally comprises a body portion or frame 310, removable freezing module 320, a freezing chamber 330 withing the body portion 310 and in fluid communication with the removable freezing module 320, a movable covering member 340, a gas distribution assembly 350 and a control module 360.

The body portion 310 may be made of rigid material such as metal or plastic. The body portion 310 may further comprise a cavity 312 for receiving the freezing chamber 330. The body portion 310 may further comprise feet 314 for supporting the apparatus 300.

The body portion 310 may also be shaped or adapted to receive a drawer 315. In some embodiment, the body portion 310 comprises a locking member 316 adapted to lock the covering member 340 over the freezing module 330 during operations.

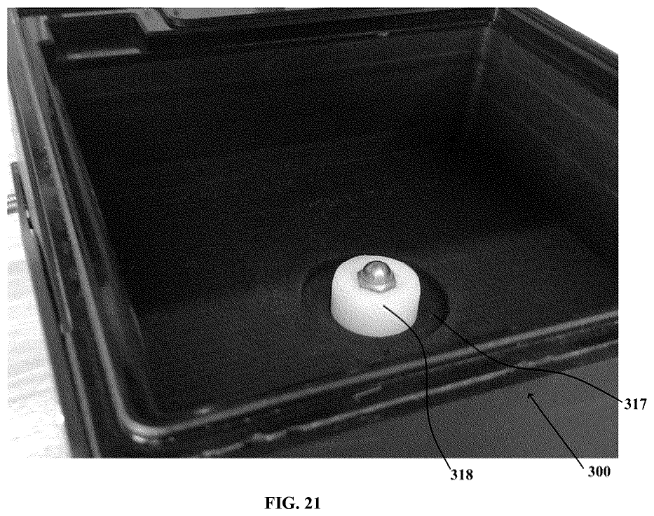

Referring to FIG. 21, the body portion 310 may further comprise an inner portion 317 adapted to receive a removable freezing chamber 330. The inner portion 317 is typically shaped according to the outer periphery of removable freezing chamber 330. The inner portion 317 may further comprise a support 318 for receiving a nozzle 351. The support 318 is generally shaped to conform with the shape of the sealing element 334 to hermetically close the freezing chamber 330. In the illustrated embodiment, the support 318 is shaped as a cylinder wherein the side walls of the cylinder receive an inner surface of the rubber or silicone ring 334. As such, the freezing chamber 330 may be mounted by inserting the rubber ring 334 over the outer surface of the support 318. The support 318 is typically made of a rigid material, such as plastic material.

Referring back to FIGS. 12 to 21, the removable freezing module 320 typically comprises a base portion 321 comprising one or more freezing cells 322. A freezing cell 322 is typically embodied as a recess in the base portion 321. The freezing module 320 may further comprise a handle 323 for manipulating the freezing module 320. Manipulation may comprise inserting the freezing module 320 over the freezing chamber 330, removing the freezing module 320 from the apparatus 300 or unmolding the frozen substances from the freezing cells 322. The handle 323 may be removable from the freezing module 320. In some embodiments, the freezing module 320 comprises a connecting member 324 matching a connecting member 325 of the handle 323. In the illustrated embodiment, the connecting member 324 is U-shaped member attached to the body 321 of the freezing module 320 and the connecting member 325 Z-shaped member adapted to be received by the U-shaped member. As such, the removable handle 323 may be inserted in the freezing cell 320 during manipulation and removed when the freezing module 320 is placed in the apparatus 300 or during operations of the said apparatus 300.

In some embodiments, each bottom portion of the freezing cells 322 may further comprise a flexible base 326 to facilitate the unmolding of the frozen liquid. The flexible base 326 may be made of silicone or any other flexible material yet resistant to freezing temperatures. The flexible base 326 may cover the entire bottom surface or may only partially cover the bottom portion. As such, when a user wishes to unmold the frozen substance, the bottom portion is flexed which applies pressure on a bottom portion of the frozen substance. The said pressure breaks the adherence of the frozen substance with inner walls of the freezing cells 322 to release the frozen substance.

The freezing chamber 330 is typically shaped to support the removable freezing module 320 and to allow a bottom portion of the freezing module 320 to be in fluid communication with the freezing chamber 330 when the freezing module 320 is installed on the apparatus 300. In the illustrated embodiment, the freezing chamber 330 is removable from the body portion 310 or the apparatus 300 itself. In such embodiment, the freezing chamber 330 comprises side walls 331 and a bottom portion 332. The bottom portion 332 comprises an aperture 333 allowing passage of the gas distribution system 350. The aperture 333 may further comprise a seal or ring 334 adapted to maintain a hermetic freezing chamber 330 during operations. In the illustrated embodiment, the seal 334 is embodied as a rubber ring. Understandably, the seal 334 may be installed on the freezing chamber 330 or around a nozzle 351 of the distribution assembly 350.

The movable covering assembly 340 generally allows the cover 340 to be vertically displaced to ease the dislodging of the cover 340 over the frozen substance present in the freezing module 320 or in the recesses 322 of the freezing module 320. In the illustrated embodiment, the movable covering assembly 340 comprises a top portion 341 adapted to cover a top portion of the freezing module 320. The movable covering assembly 340 further comprises a vertical expansion and retraction assembly 342 adapted to upwardly move the top portion 341 and to downwardly move the top portion 341 over the freezing module 320. In the illustrated embodiment, the vertical expansion and retraction assembly 342 is motorized. In such embodiment, the assembly 342 further comprises two linear actuators 343 and a motor 344. The linear actuators 343, or cylinders, are connected at one end to the top potion 341 and at the other end to a bottom portion of the body 310.

In the illustrated embodiment, the top portion 341 is cantilevered over the linear actuators 343. Understandably, the top portion 341 could be supported by any number of linear actuators 343 or passive sliders (not shown), such as having support at each corner of the top portion 341.

In the present embodiment, the apparatus 300 further comprises a power source 370, such as a battery or power cord. The power source 370 is connected to the motor 344 and the motor 344 is in data communication with the control system 360. The covering member 340 may further comprise a cold transfer assembly 345 underneath the top portion 341. The cold transfer assembly 345 may comprise nipples 346 or other protruding member aligned with the freezing cells 322 of the freezing module 320. The protruding members 346 may be shaped according to the recesses 322 of the freezing module 320 to allow energy transfer and to improve efficiency of the freezing process. The cold transfer assembly 345 may be removable from the top portion 341 and interchangeable to use protruding members 346 having different shapes matching the freezing cells 322.

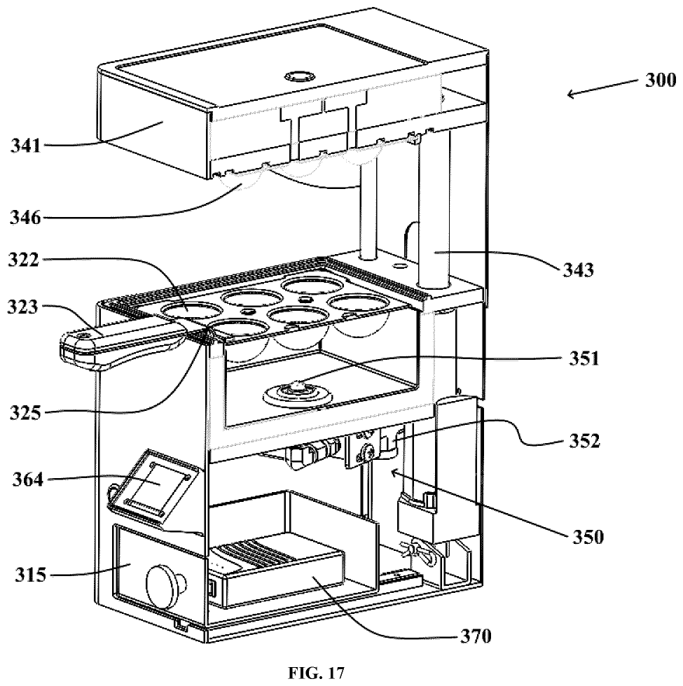

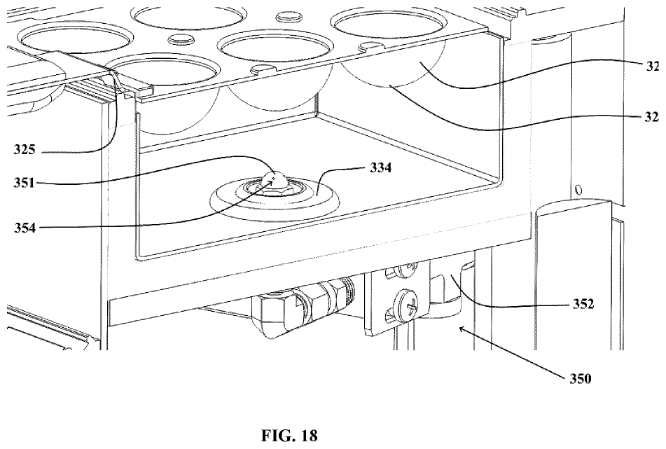

The gas distribution assembly 350 may comprise a nozzle 351, a valve 352, and a gas container 353. The gas container 353 is fluidly connected to the nozzle 351 via a pipe or hose. The valve 352 control the flow and debit of gas toward the nozzle 351 released from the gas container 353. The nozzle 351 may comprise a plurality of apertures or holes 354. The nozzle 351 is typically centrally positioned through a central aperture of the freezing chamber 330. Understandably, in other embodiments, the gas distribution assembly 350 may comprise a plurality of nozzles 351 at different positions in the freezing chamber 330. Referring to FIGS. 17 and 18, an embodiment of a central nozzle 351 comprising four holes 354 is illustrated. The apertures 354 are typically distributed to project gas in all directions inside the freezing chamber 330.

In some embodiments, the holes may be oriented in such a way that the gas flowing through the nozzle 351 is dispersed through out the freezing chamber 330. The central nozzle 351 may further comprise an anti-clog mechanism 355 and the holes may have predetermined dimensions that prevent the formation of dry ice.

In yet other embodiments, the valve 352 is intermittently opened and closed through out the freezing process at a predetermined frequency to optimize or limit the use of gas. As such, the valve 352 may be a solenoid valve, a motorized ball valve or even a valve connectable to a network. As such, the gas distribution assembly 350 may be in data communication with the control module 360 and may be automatically controlled by the control module 360. In some embodiments, the valve is open and close at a frequency of about 2 Hz.

The control module 360 may comprise a printed circuit board (PCB) or controller 361 powered by the power source 370, a display unit 364, and one or more control buttons 365. The PCB or controller 361 may be connected to the linear actuators 343 to control opening and closing of the covering member 340. As discussed above, the PCB 361 may further be in communication with the valve 352 to control opening and closing of the said valve 352. As such, the PCB 361 may be programmed to open the valve at predetermined frequencies. In yet other embodiments, the freezing chamber 330 may further comprise one or more temperature sensors (not shown). The PCB 361 may be programmed to use the readings from the temperature sensors to open or close the valve in order to control the temperature within the freezing chamber.

The PCB may further be programmed to provide a timer function in which the valve 352 is open to allow gas flowing within the freezing chamber 330. The PCB may further be programmed to provide specific or predetermined modes of operations of the apparatus 300. As an example, depending on the specific substance to be frozen, the control module 360 may be configured to provide a specific mode to control the intermittent opening and closing of the valve 352 at a specific frequency. The predetermined modes may further be adjusted by the user to allow a personalized freezing process.

The display unit 364 may be embodied as a touch screen to allow interactions of the user with the apparatus 300. The display unit 364 may be configured to provide a user interface for the user to interact with the control module 360. The control module 360 may further comprise a button 367 to turn on and turn off the apparatus 300, and a button 367 to control the screen 364. The control module 360 may further comprise a mechanism to automatically turn the apparatus 10 off, for instance to save the energy of the power source 370. The control module 360 may further be programmed to automatically lower or raise the covering member 340 at the beginning or at the end of the freezing process.

In use, the apparatus 300 is first connected to the gas container using a hose or any other gas-resistant tube. The covering member 340 of the apparatus 300 may be raised to provide an access to the freezing module 320 and/or freezing chamber 330. The freezing cells 322 of the freezing module 320 are filled or at least partially filled with a substance to be frozen. The cover 340 is lower to seal the freezing module at least partially within the apparatus 300. The control module 360 sends a signal to the valve to open and close the valve to let a flow of gas within the freezing chamber 330. The control module 360 may start a timer to let the substance freezes while the cover 340 is lowered. When the timer is elapsed, the control module 360 may send a signal to the linear actuator to automatically vertically moves the cover 340. The vertical motion of the cover 340 aims at breaking any adherence that may be created between the freezing substance and the top portion 341.

A user may then remove the freezing module 320 from the apparatus 300 to unmold the frozen substance. In some embodiments, the user applies a pressure on a flexible bottom portion of the freezing cells 322 to release and unmold the frozen substance. In other embodiments, the user may first connect or detachably mount a handle to the freezing module 330 prior to removing the said freezing module 330. Following the installation of the freezing module 330 in the apparatus, the handle may be detached from the freezing module 320.

In yet other embodiments, the user may remove the freezing chamber 330 from the apparatus. Once remove, the freezing chamber 330 may be inspected and/or cleaned for future uses. The freezing chamber 330 may be upwardly pulled to release the freezing chamber from the nozzle 351 and/or the seal.

While illustrative and presently preferred embodiments of the invention have been described in detail hereinabove, it is to be understood that the inventive concepts may be otherwise variously embodied and employed and that the appended claims are intended to be construed to include such variations except insofar as limited by the prior art.

1. An apparatus for freezing a substance comprising:
a frame;
a freezing chamber in fluid communication with a gas;
a removable freezing module comprising at least one recess portion and a bottom portion in fluid communication with the freezing chamber;
a gas distribution assembly for controlling a flow of the gas in the freezing chamber;
a covering assembly movable along an axis substantially perpendicular to the removable freezing module.

2. The apparatus of claim 1, the covering assembly comprising a top portion covering a top portion of the removable freezing module.

3. The apparatus of claim 2, the top portion comprising a thermic transfer assembly comprising protuberances for increasing thermic transfer to the substance to be frozen.

4. The apparatus of claim 3, the thermic transfer assembly being removable from the top portion.

5. The apparatus of claim 2, the covering assembly comprising a vertical expansion and retraction assembly for upwardly and downwardly moving the top portion.

6. The apparatus of claim 5, the top portion being substantially perpendicular to the vertical expansion and retraction assembly.

7. The apparatus of claim 5, the top portion being cantilevered by the vertical expansion and retraction assembly.

8. The apparatus of claim 5, the vertical expansion and retraction assembly being motorized.

9. The apparatus of claim 8, the vertical expansion and retraction assembly comprising a linear actuator connected to the top portion and to the frame of the apparatus.

10. The apparatus of claim 9 further comprising a control module, the control module being in communication with the linear actuator to control upward and downward movements of the linear actuator.

11. The apparatus of claim 5, the vertical expansion and retraction assembly automatically raising the top portion following completion of a freezing process.

12. The apparatus of claim 1, the freezing chamber being removable.

13. An apparatus for freezing a substance comprising:
a frame;
a removable freezing chamber in fluid communication with a gas;
a removable freezing module comprising at least one recess portion and a bottom portion in fluid communication with the freezing chamber;
a gas distribution assembly for controlling a flow of the gas in the freezing chamber and passing through the removable freezing chamber.

14. The apparatus of claim 12, the removable freezing chamber further comprising a bottom portion having an aperture to allow passage of the gas distribution assembly.

15. The apparatus of claim 13, the removable freezing chamber further comprising a sealing member for hermetically connecting with the gas distribution assembly.

16. The apparatus of claim 14, the sealing member being a ring made of resilient material.

17. The apparatus of claim 12, the gas distribution system comprising a nozzle comprising a plurality of openings for letting gas flows in the removable freezing chamber, the openings being oriented to disperse gas through a plurality of distinct directions in the removable freezing chamber.

18. The apparatus of claim 17, the nozzle being surrounded by a sealing member to maintain the removable freezing chamber hermetic during operations.

19. The apparatus of claim 17, the nozzle comprising an anti-clogging mechanism.

20. The apparatus of claim 17, the openings of the nozzle having predetermined dimensions to prevent formation of dry ice.

21. An apparatus for freezing a substance comprising:
a frame;
a freezing chamber in fluid communication with a gas;
a removable freezing module comprising at least one recess portion and a bottom portion in fluid communication with the freezing chamber;
a controller;
a gas distribution assembly for controlling a flow of the gas in the freezing chamber and passing through the freezing chamber in communication with the controller.

22. The apparatus of claim 21, the gas distribution assembly comprising an electronic valve in communication with the controller.

23. The apparatus of claim 22, the controller being programmed to intermittently open and close the valve to optimize use of a flow of the gas.

24. The apparatus of claim 21 further comprising a temperature sensor within the gas chamber, the temperature sensor being in communication with the controller.

25. The apparatus of claim 24, the controller being programmed to open or close the valve based on the readings of the temperature sensor.

26. The apparatus of claim 22, the controller further comprising a display unit.

27. A freezing module for an apparatus for freezing a substance, the freezing module comprising:
at least one recess portion for receiving the substance to be frozen;
at least one bottom portion to be received by a freezing chamber of the apparatus;
a removable handle for manipulating the freezing module.

28. The freezing module of claim 27 further comprising a first connecting member and the removable handle comprising a second connecting member, the first connecting member being detachably mountable to the second connecting member.

29. The freezing module of claim 28, the first connecting member being U-shaped and the second connecting member being Z-shaped.

30. A freezing module for an apparatus for freezing a substance, the freezing module comprising:
at least one recess portion for receiving the substance to be frozen comprising a bottom portion at least partially cover by a flexible material;
at least one bottom portion to be received by a freezing chamber of the apparatus.

31. The freezing module of claim 30, the flexible material being silicone.

32. The freezing module of claim 31, the flexible material covering all of the bottom portion of the recess portion.

33. A method to automatically freeze a substance comprising:
at least partially filing a freezing module with the substance to be frozen;
automatically sealing the freezing module to form a freezing chamber;
letting gas to flow in the freezing chamber for a predetermined period;
unsealing the freezing module following freezing of the substance.

34. The method of claim 33 further comprising attaching a handle to the freezing module and manipulating the freezing module with the attached handle.

35. The method of claim 34 further comprising detaching the handle from the freezing module.

36. The method of claim 33 further comprising detecting the temperature within the freezing chamber and stopping flow of gas when the detected temperature reaches a predetermined value.

37. The method of claim 33 further comprising inserting a freezing chamber module prior to sealing the freezing module.

38. The method of claim 37 further comprising removing the freezing chamber module.

39. The method of claim 33 further comprising automatically covering the freezing module.

40. The method of claim 39 further comprising actuating a covering member to upwardly move toward and downwardly move away from the freezing module.

41. A cartridge connecting assembly for an apparatus to freeze a substance, the cartridge connecting assembly comprising:
a cartridge mount;
a cartridge connector operatively connectable to a fluid cartridge and connectable to a fluid injector assembly of the apparatus;
a valve mount adapted to receive a valve stem of the receivable fluid cartridge.

42. The cartridge connecting assembly of claim 41, the cartridge connector being adapted to receive and maintain the fluid cartridge in a downward position.

43. The cartridge connecting assembly of claim 41, the cartridge mount comprising a mounting plate having an aperture and a retaining sleeve attachable to the apparatus.

44. The cartridge connecting assembly of claim 41 being vertically moving in relation to the apparatus.

45. The cartridge connecting assembly of claim 41 further comprising a securing member.

46. The cartridge connecting assembly of claim 45, the securing member comprising a knob to compress a nozzle of the cartridge within the connecting assembly.

47. The cartridge connecting assembly of claim 41 further comprising one or more alignment members to receive a nozzle of the cartridge.
